(19) United States
(12) Patent Application Publication
(10) Pub. No.: US 2018/0170149 A1
(43) Pub. Date: Jun. 21, 2018

(54) AIR REGISTER WITH HYBRID DOOR CLOSURE

(71) Applicant: FORD GLOBAL TECHNOLOGIES, LLC, Dearborn, MI (US)

(72) Inventor: Steve Nicholas Fidh, Ann Arbor, MI (US)

(21) Appl. No.: 15/385,132

(22) Filed: Dec. 20, 2016

(51) Int. Cl. B60H 1/00

(52) U.S. Cl. CPC B60H 1/00564; B60H 2001/3471; B60H 1/00964; B60H 1/0065

(57) ABSTRACT

A hybrid actuator system for a vehicle vent register damper includes a manual actuator mechanism operatively connected to a vent register damper and a power actuator mechanism operatively connected to a portion of the manual actuator mechanism. The power actuator mechanism includes a position member operatively connected to a power actuator and to the portion of the manual actuator mechanism. A controller is operatively linked to the power actuator. Vehicle vent registers including the hybrid actuator system and methods for operating a vehicle vent register damper using the hybrid actuator system are described.

### TECHNICAL FIELD

This disclosure relates generally to air vents and air vent registers for dispensing conditioned air from a vehicle heating, ventilation, and air conditioning (HVAC) system. More particularly, the disclosure relates to an air vent register including a hybrid actuator system allowing both manual and electronic control of air flow distribution through various air registers to improve HVAC performance, power use efficiency, and vehicle occupant comfort and satisfaction.

### BACKGROUND

The basic design of a vehicle vent register is well-known and does not require extensive description herein. However, at a high level and with reference to FIG. 1, a vent register 100 includes a housing 102 and one or more vanes 104. The housing 102 is typically configured and dimensioned for insertion into and attachment to a cooperating aperture (not shown) in a vehicle component such as a dash panel, door trim panel, roof trim panel, center console, etc. The housing 102 is typically positioned at a terminal end of a vehicle HVAC duct (not shown) whereby the duct is in fluid communication with the housing interior such that conditioned air from the HVAC passes through the housing 102 and therefrom into the vehicle passenger cabin (not shown). The vanes 104 are typically pivotally attached to the housing to direct a flow of conditioned air from the vehicle HVAC (not shown) through the vent register 100 and into a vehicle passenger cabin (not shown). A thumbwheel 103 or other actuator may be included for operating a damper (not shown) which regulates the flow of conditioned air from the vehicle heating, air-conditioning, and ventilation (HVAC) system (not shown) allowed to enter/exit the vent register 100, A vane actuator 105 may also be included for altering the angle at which conditioned air exits the vent register.

Currently, electronic control of air flow distribution via an HVAC system is limited to mechanisms disposed within the HVAC case which apply controls before the air flow enters the vehicle duct system/air registers. Such systems also typically only adjust airflow automatically according to determined overall passenger cabin temperature, not by individual vent register control. It is left to the vehicle occupant to mechanically set the air flow distribution in the vehicle passenger cabin to her liking by adjusting the air register mechanisms mechanically, usually by way of a thumbwheel 103 or other actuator that translates a damper or a series of vanes between an open and a closed position. While effective, there are limitations to this system. In particular, when the driver is the only occupant of the vehicle, she can only adjust the air flow to her liking for the air register(s) closest to the driver's seat. Because it may be the case that excess and unnecessary air flow is being directed to unoccupied vehicle seats, this can result in inefficient power use. To compensate for the air flow passing through other air registers of the vehicle, the driver may also have to adjust the air register(s) closest to the driver's seat to provide a greater or a lesser airflow than would otherwise be the case.

Accordingly, a need is identified in the art for improved systems and methods for controlling airflow through particular vent registers and/or groups of air vent registers. To solve this and other problems, the present disclosure relates to a hybrid actuator system for a vehicle vent register damper, to vent registers including the hybrid actuator system, and to methods for operating a vent register damper using the hybrid actuator system.

### SUMMARY

In accordance with the purposes and benefits described herein, in one aspect of the present disclosure a hybrid actuator system is provided for a vehicle vent register damper, comprising a manual actuator mechanism operatively connected to a vent register damper and a power actuator mechanism operatively connected to a portion of the manual actuator mechanism.

In embodiments, the manual actuator mechanism comprises a lever operatively connected to the vent register damper and a manual actuator operatively connected to the lever for translating the vent register damper between a fully open position and a fully closed position. The manual actuator may be a thumbwheel or other suitable manual actuator.

In embodiments, the power actuator mechanism comprises a position member operatively connected to a power actuator and to the lever. The position member includes a body having an arcuate slot interfacing with a portion of the lever. The position member is configured whereby a neutral position is possible whereby the lever may be manually actuated to open and close the vent register damper without contacting the arcuate slot.

A position sensor may be operatively associated with the power actuator. A controller is operatively associated with the power actuator and/or the position sensor.

In another aspect, a vent register for a vehicle is provided, including a housing and a damper carried by the housing. The damper is actuable to at least partially block an airflow from an HVAC system by way of the hybrid actuator system as described above.

In yet another aspect, a method for controlling an airflow through one or more vehicle vent registers is described. The method includes providing a manual actuator mechanism operatively connected to a vent register damper and a power actuator mechanism operatively connected to a portion of the manual actuator mechanism. A controller causes the power actuator mechanism to translate the vent register damper to a desired orientation according to one or more predefined conditions. In embodiments, the manual actuator mechanism and the power actuator mechanism are as described above.

The described method further includes steps of, by the power actuator under control of the controller and optionally the position sensor, holding the position member in a neutral orientation whereby the lever is not moved by the position member during a manual actuation of the vent register damper by the manual actuator mechanism. On determining a one of the one or more predefined conditions, the power actuator under control of the controller and optionally the position sensor translates the position member from the neutral position sufficiently to cause the lever to translate the vent register damper to the desired orientation at or between a fully open position and a fully closed position.

In embodiments, the one or more predefined conditions are selected from the group consisting of detecting an unoccupied vehicle seat, detecting a vehicle heating, air conditioning, and ventilation (HVAC) system defrost mode, determining a need for operation of a specific zone of a multiple-zone HVAC system, determining a need for altering a temperature of a specific zone of the multiple-zone HVAC system, and determining a need for adjusting a combined airflow allowed through two or more vent registers.

In the following description, there are shown and described embodiments of the disclosed hybrid actuator system for a vehicle vent register damper, vent registers including the hybrid actuator system, and methods for operating a vent register damper using the hybrid actuator system. As it should be realized, the devices and methods are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed hybrid actuator system for a vehicle vent register damper, and also vent registers and methods incorporating same, and together with the description serve to explain certain principles thereof. In the drawings:

FIG. 1 depicts a prior art vehicle vent register;

FIG. 2 shows a front perspective view of a vehicle vent register including a hybrid actuator system for a vehicle vent register closure according to the present disclosure;

FIG. 3A shows manual operation of a vent register damper using a manual actuator system of the hybrid actuator system of FIG. 2, with a vent register damper in a fully open position;

FIG. 3B shows manual operation of the vent register damper using the manual actuator system of the hybrid actuator system of FIG. 2, with the vent register damper in a partially closed position;

FIG. 4A shows an initial phase of closing of a vent register damper using a power actuator mechanism of the hybrid actuator system of FIG. 2;

FIG. 4B shows an intermediate phase of closing of the vent register damper of FIG. 4A using the power actuator mechanism of the hybrid actuator system of FIG. 2;

FIG. 4C shows a final phase of closing of the vent register damper of FIG. 4A using the power actuator mechanism of the hybrid actuator system of FIG. 2;

FIG. 5 schematically depicts a vehicle passenger cabin including a multiple-zone vent register arrangement; and

FIG. 6 depicts in flow chart form a method for operating the hybrid actuator system of FIG. 2.

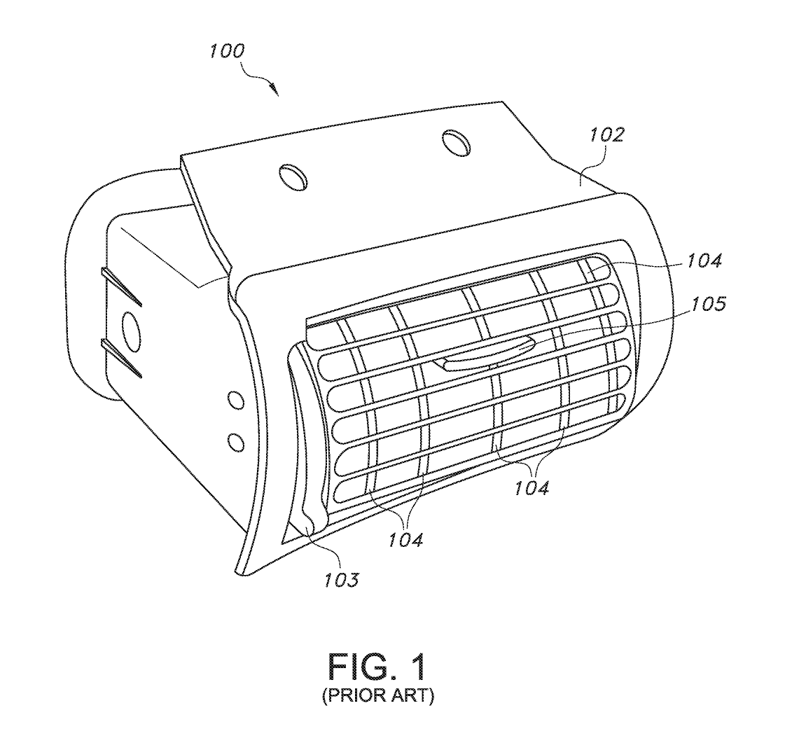

Reference will now be made in detail to embodiments of the disclosed vent register for a motor vehicle, examples of which are illustrated in the accompanying drawing figures.

### DETAILED DESCRIPTION

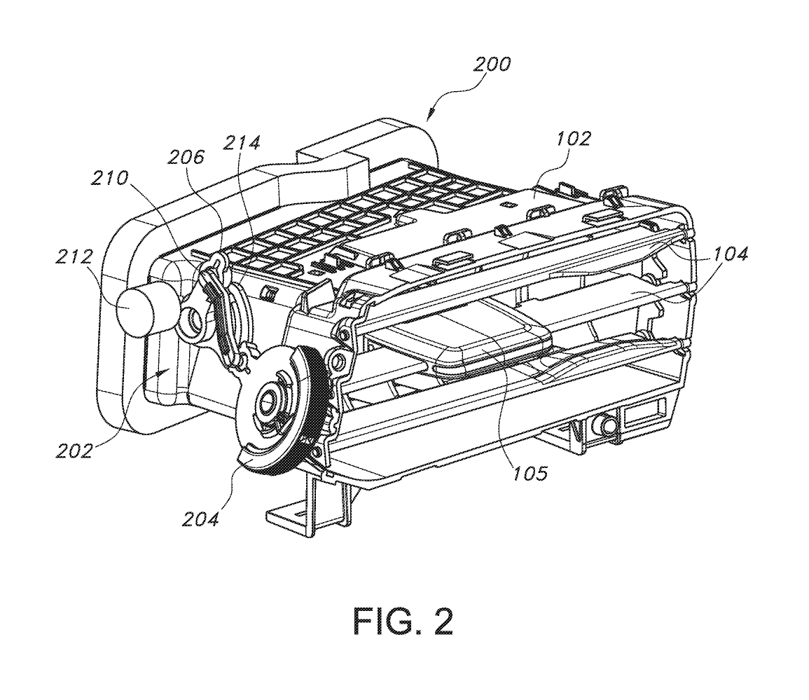

Referring now to FIG. 2, there is shown a vent register 200 including a hybrid actuator system 202 for a vehicle vent register damper (not shown in this view). As with prior art vent registers, the vent register 200 includes a housing 102, a series of parallel vanes 104 for controlling a direction of airflow, and a vane actuator 105 for altering the angle at which conditioned air exits the vent register. Of course, other configurations of vanes 104 are known and are contemplated for use herein, for example round vanes comprising concentric rings having a central pivot or Cardin joint, and others.

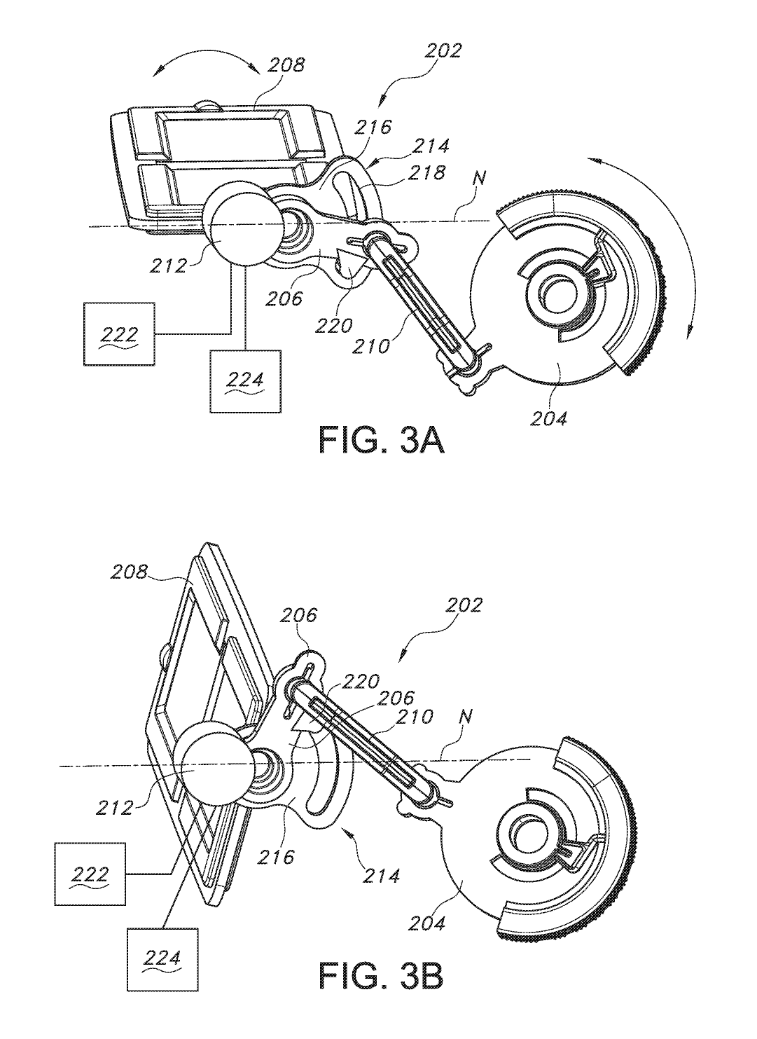

The hybrid actuator system 202 is shown in isolation in FIGS. 3A-3B, and includes a manual actuator mechanism including a manual actuator 204 and a lever 206 which operates to pivot a vent register damper 208 carried by the housing 102. The lever 206 operates to pivot the vent register damper 208 to a desired orientation between a fully closed position preventing airflow through the vent register 200 and a fully opened position allowing full airflow through the vent register. In the depicted embodiment, the manual actuator 204 is a thumbwheel connected to the lever 206 by a link 210, which on rotation (see arrow) causes the lever to pivot upwardly or downwardly as desired. The skilled artisan will appreciate that other manual actuators 204 are contemplated, such as actuator levers, slides, push/pull knob and cable arrangements, fully exposed rotating knobs, rotating trim rings, etc. Also, the skilled artisan will appreciate that the manual actuator 204 may be directly connected to the lever 206 rather than indirectly, such as by known means of mechanical adjustment including assemblies or series of planar or non-planar gears.

The hybrid actuator system 202 further includes a power actuator mechanism having a power actuator 212 operatively connected to a position member 214. The position member 214 includes a body 216 defining a slot 218 which as shown engages a portion of the lever 206. In the depicted embodiment the position member 214 engages a pin 220 carried by the lever 206. As is shown, the slot 218 defines an arcuate shape, and is dimensioned whereby only the terminal ends of the slot actually contact the pin 220 when the position member has rotated a sufficient distance. The reason for this will be explained in greater detail below.

The position member 214 may be located concentric to the damper 208 axis or to the manual actuator 204 axis. In an alternative embodiment (not shown), the vent register damper 208 may be actuated by a series of gears. In this embodiment, the position member 214 may comprise a portion of an idle gear. The power actuator 212 may be directly connected to the position member 214 as shown, or may in an alternative embodiment (not shown) be operatively connected to the position member by a series of links or gears. The power actuator 212 may be an electric motor, or a fluid or air driven actuator operatively associated with a pressure vessel or tank which provides the driving fluid/air.

The hybrid actuator system 202 also includes a controller represented generally as reference numeral 222, and may include a position sensor represented generally as reference numeral 224. The controller 222 may be an on-board controller such as a vehicle Electronic Control Unit (ECU), which may include without intending any limitation the Electronic Control Module (ECM), Central Control Module (CCM), General Electronic Module (GEM), and others. Alternatively, the controller 222 may be a separate stand-alone controller configured only to control of the power actuator 212. Still further, the power actuator 212 may be controlled by various combinations of controllers as referenced above. The position sensor 224 may be integrated into the power actuator 212 or may be a stand-alone device. Without intending any limitation, devices suitable as position sensors 224 may include a potentiometer, an encoder, a series of discrete switches, optical sensors, and others.

A feature of the above-described system allowing the hybrid actuation will now be described. As shown in FIGS. 3A and 3B, during manual actuation of the vent register damper 208 the power actuator 212, under control of the controller 222 and optionally the position sensor 224, maintains the position member 214 in a neutral orientation N whereby the lever 206 and pin 220 traverse the full length of the slot 218 without making contact therewith. Thus, the vent damper 208 can be translated between the fully opened configuration of FIG. 3A and the fully closed configuration of FIG. 3B, or any intermediate configuration therebetween, without any contact between the pin 220 and the slot 218.

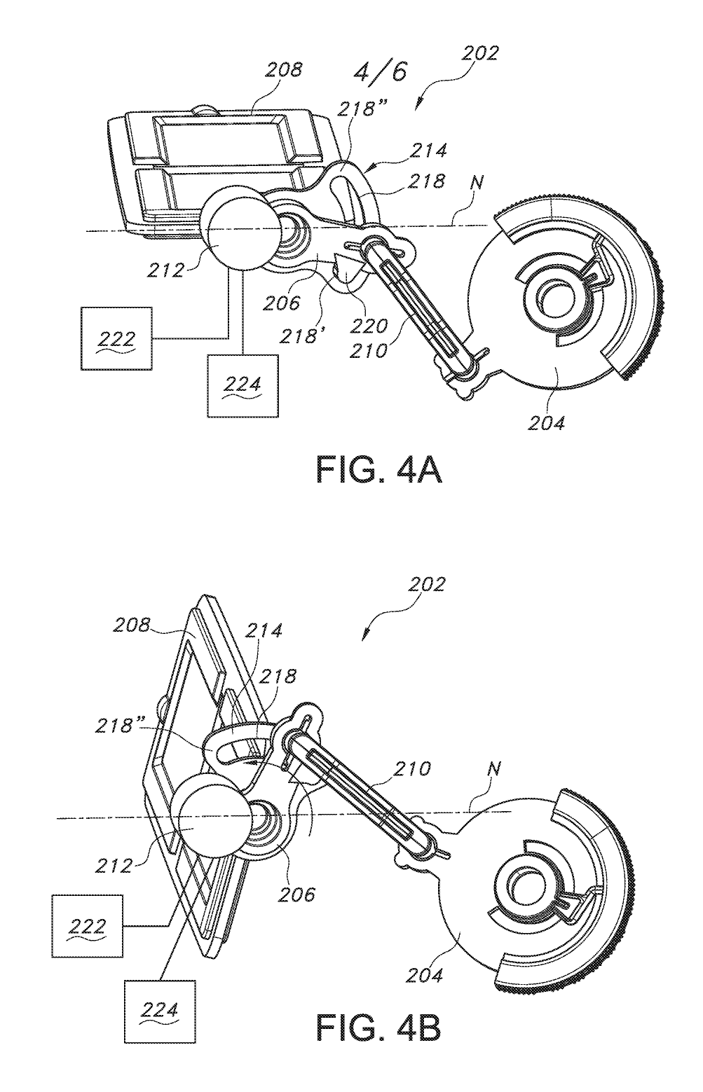

On the other hand, when power rather than manual actuation of the vent register damper 208 is needed or desired the position member 214 is translated by the power actuator 212 from the neutral position N. This is illustrated in FIGS. 4A-4C showing a powered closing of the vent register damper 208. FIG. 4A shows the vent register damper 208 in the fully open configuration. On receipt of a signal from the controller 222 and/or the position sensor 224, the power actuator 212 translates the position member 214 and slot 218 whereby an end 218′ of the slot contacts the lever pin 220, causing the lever 206 to translate the vent register damper 208 to the closed position (see FIG. 4B). Then, the power actuator 212 under control of the controller 222 and/or the position sensor 224 returns the position member 214 to the neutral position N (see FIG. 4C). To return the vent register damper 208 to the fully opened position, the process is reversed whereby an opposed end 218″ of the position member slot 218 contacts the lever pin 220, causing the lever to translate the vent register damper to the open position of FIG. 4A.

As will be appreciated, various embodiments are possible for control of the position member 214 by the power actuator 212. For example, the power actuator 212 may be a drive motor providing a fixed-distance translation of the position member 214 whereby the vent register damper 208 may only be translated between the fully opened and fully closed configurations shown in FIGS. 3A-3B and 4A-4C. Alternatively, the controller 222 and position sensor 224 may define a range of intermediate orientations for the vent register damper 208, thus allowing a range of airflows to pass through the vent register 200.

In turn, other operative connecting members between the position member 214 and the manual actuator 204 are contemplated. The important point is that the position member 214 defines a greater range of travel than the member connecting the position member to the manual actuator 204, to allow the functions described above.

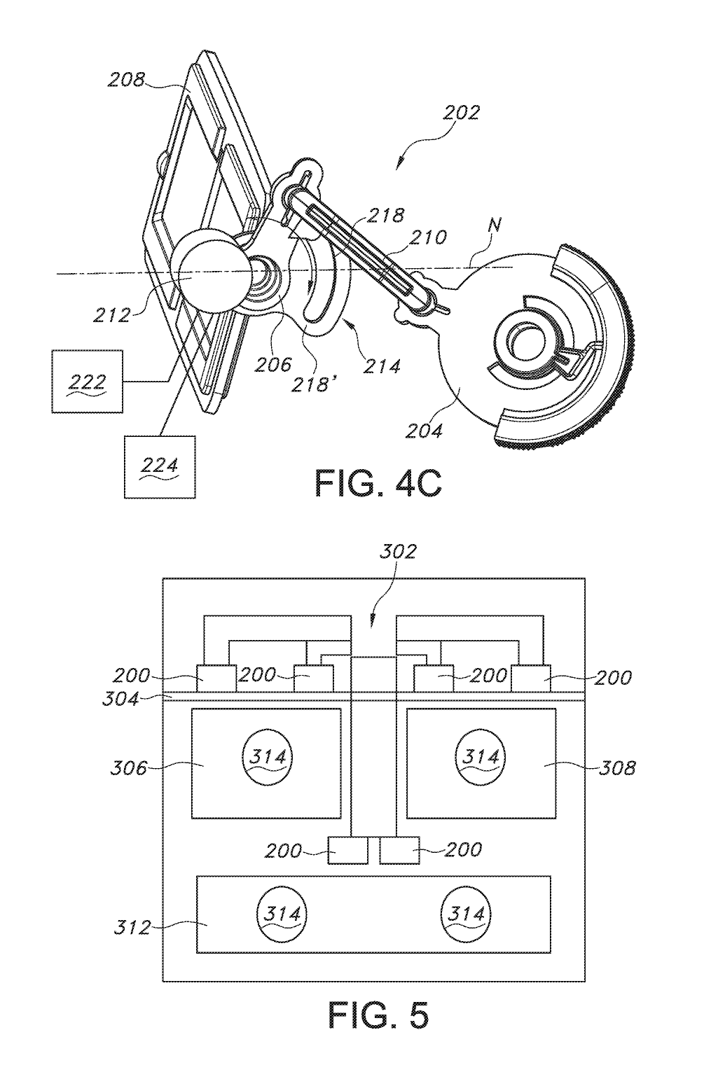

The described hybrid actuator system 202 finds use in a variety of situations. For example, FIG. 5 schematically depicts a vehicle passenger cabin 300, including an HVAC duct 302 arrangement. The above-described vent registers 200 are shown in fluid communication with the HVAC ducts, in the depicted embodiment being associated with an instrument panel 304 for front seat 306, 308 heating/cooling and with a rear of a center console 310 for rear seat 312 cooling/heating. The vent registers 200 each include a hybrid actuator system 202 (not shown) as described above.

As is known, such HVAC duct 302 arrangements define a multiple-zone environment wherein different zones of the passenger cabin 300 may be differently heated/cooled by altering airflow entering particular zones. For example, the front seats 306, 308 may represent one zone, and the rear seat 312 may represent another zone. Alternatively, the left side front seat 306 could be a zone, the right side front seat 308 could be a zone, and the rear seat 312 could be a zone. As discussed above, conventionally the only way for vehicle occupants to separately control airflow to such zones was manually.

By use of the described hybrid actuator system 202 under control of a controller 222 and/or position sensor 224 as described, automated control of airflow into various zones of the passenger cabin 300 is made possible, with such control of airflow occurring at the air vent registers 200 rather than centrally within the HVAC case (not shown). Particular situations wherein such individual control of airflow would be beneficial can be envisioned. For example, a driver may be the only occupant of a vehicle passenger cabin 300, and in that case airflow would only be necessary through the vent registers 200 closest to the seat 306. Alternatively, the driver and a child placed in a child seat (not shown) on the rear seat 312 may be occupying the passenger cabin 300, and in that case airflow through the vent registers 200 closest to the seat 306 and seat 312 would be needed.

In such situations, detection of passengers in particular seats could be accomplished by use of seat occupancy sensors 314, for example seat-mounted sensors 314, cameras (not shown), or by other detection systems. A variety of such seat-mounted seat occupancy sensors 314 are known, for example pressure sensors. Such seat occupancy sensors 314 would communicate with the controller 222 or with another controller (not shown) which in turn communicates with controller 222, indicating a need for airflow to the seat associated with the sensor. In this manner, airflow to occupied seats in the passenger cabin 300 could be established at a reduced overall vehicle airflow, since unnecessary airflow to unoccupied seats is prevented. This would reduce energy costs and component wear and tear, since the HVAC compressor (not shown) would not need to cycle on and off as frequently to provide the desired airflow.

Other representative situations are possible. For example, when both seat 306 and seat 308 are occupied, it may be desirable to balance air flow between the vent registers 200 closest to those seats, to thereby balance airflow between the left and right sides of the passenger cabin 300 at a reduced energy cost. This could be accomplished automatically by use of the described hybrid actuator system 202. Again, the presence of occupants in the indicated seats 206, 308 could be accomplished by sensors 314 communicating with the controller 222 or another controller (not shown) which in turn communicates with controller 222. In yet another example, when an HVAC system is placed in defrost mode, it is necessary to provide some airflow to outer vent registers of the passenger cabin 300 to prevent condensation on the front windows. This could be accomplished by the hybrid actuator system 202 described herein by automatically causing the center vent register dampers 208 to close when the HVAC system is placed in defrost mode, whereby airflow or bleed is provided to the vehicle-outboard vent registers 200 during a defrosting operation.

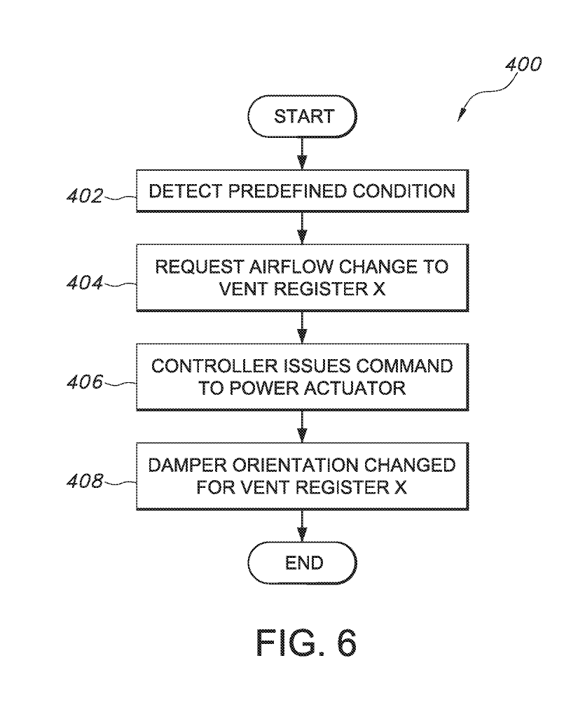

To address these and other predefined conditions, the controller 222 may be programmed with logic causing the hybrid actuator system 202 power actuator 212 to translate the vent register damper 208 to a desired orientation providing a desired airflow through a particular vent register 200 or set of vent registers 200 on detecting the predefined condition. This method 400 for controlling airflow is illustrated at a high level in FIG. 6.

As shown therein, the process begins (step 402) by detection of a predefined condition. As described above, this could be detection of vehicle occupants in one or more zones of a passenger cabin 300 by way of sensors 314, a determination that a vehicle HVAC system has been placed in defrost mode, a determination that airflow to different sides of a passenger cabin 300 requires balancing, etc. This predefined condition could be communicated to the controller 222 directly or indirectly by way of another controller.

The controller 222 is programmed with logic defining various vent register damper 208 settings to be implemented on receipt of such an indication of a predefined condition, which could be stored in memory as a look-up table. A representative look-up table is shown below in Table 1, showing various pre-programmed damper 208 orientations for particular vent registers 200 of a passenger cabin 300, for example at the driver's seat outboard vent register (LHOB), driver's seat inboard vent register (LHIB), passenger's seat outboard vent register (RHOB), passenger's seat inboard vent register (LHIB), and rear seat/second row vent registers.

In the top one of the two highlighted example predefined conditions, the driver's and the front passengers' seats of the passenger cabin 300 are occupied and the HVAC system is set on panel mode. In that situation, the signals provided by the combination of seat occupancy sensors 314 (Step 404) and an HVAC mode sensor (not shown) which detects that a vehicle occupant has selected an HVAC defrost mode, or alternatively that a control head (not shown) has automatically placed the HVAC in defrost mode according to various inputs, would indicate from the look-up table that the RHIB and RHOB vent registers 200 should be opened and the remaining vent registers should be closed. Accordingly, as described above the controller 222 would cause the power actuators 212 associated with those two vent registers 200 (Step 406) to translate their vent register dampers 208 to the fully closed position (Step 408) as determined by the position sensor 224.

In the bottom one of the two highlighted example predefined conditions, the front passenger and second row seats are occupied and the HVAC system is set on defrost. In this situation, the signals provided by the combination of seat occupancy sensors 314 and an HVAC mode sensor (not shown) (Step 404) would indicate from the look-up table that the LHIB and RHIB vent registers 200 should be closed and the remaining vent registers should be opened. Accordingly, as described above the controller 222 would cause the power actuators 212 associated with those two vent registers 200 (Step 406) to translate their vent register dampers 208 to the fully closed position (Step 408) as determined by the position sensor 224.

Obvious modifications and variations are possible in light of the above teachings. For example, the disclosure depicts and describes a pivoting vent register damper 208. However, alternative damper configurations are known in the art such as rotating disc dampers, sliding dampers, etc., and such are contemplated for use herein also. In turn, while the descriptions above are generally directed to dual HVAC zone vehicles, the skilled artisan will readily appreciate that the described devices and methods are equally applicable to single HVAC zone vehicles. Therefore, the disclosure should not be taken as limiting in these respects.

All such modifications and variations are within the scope of the appended claims when interpreted in accordance with the breadth to which they are fairly, legally and equitably entitled.

What is claimed:

1. A hybrid actuator system for a vehicle vent register damper, comprising:
a manual actuator mechanism operatively connected to a vent register damper; and
a power actuator mechanism operatively connected to a portion of the manual actuator mechanism.

2. The hybrid actuator system of claim 1, wherein the manual actuator mechanism comprises a lever operatively connected to the vent register damper and a manual actuator operatively connected to the lever for translating the vent register damper between a fully open position and a fully closed position.

3. The hybrid actuator system of claim 2, wherein the manual actuator is a thumbwheel.

4. The hybrid actuator system of claim 2, wherein the power actuator mechanism comprises a position member operatively connected to a power actuator and to the lever.

5. The hybrid actuator system of claim 4, wherein the position member includes a body having an arcuate slot interfacing with a portion of the lever.

6. The hybrid actuator system of claim 4, further comprising a position sensor operatively associated with the power actuator.

7. The hybrid actuator system of claim 6, further including a controller operatively associated with the power actuator and/or the position sensor.

8. A vent register including the hybrid actuator system of claim 1.

9. A vent register for a vehicle, comprising:
a housing in fluid communication with a duct system providing an airflow to a passenger cabin interior;
a damper carried by the housing and actuable to at least partially block the airflow;
a manual actuator mechanism operatively connected to the damper; and
a power actuator mechanism operatively connected to a portion of the manual actuator mechanism.

10. The vent register of claim 9, wherein the manual actuator mechanism comprises a manual actuator operatively connected to a lever for opening and closing the damper.

11. The vent register of claim 10, wherein the power actuator mechanism comprises a power actuator driving a position member that is operatively connected to a portion of the lever.

12. The vent register of claim 9, wherein the power actuator mechanism further comprises a position sensor operatively associated with the power actuator.

13. The vent register of claim 9, further including a controller operatively associated with the power actuator and/or the position sensor.

14. A method for controlling an airflow through one or more vehicle vent registers, comprising:
providing a manual actuator mechanism operatively connected to a vent register damper and a power actuator mechanism operatively connected to a portion of the manual actuator mechanism; and
by a controller operatively connected to the power actuator mechanism, actuating the power actuator mechanism to translate the vent register damper to a desired orientation according to one or more predefined conditions.

15. The method of claim 14, including providing a manual actuator mechanism comprising a manual actuator operatively connected to a lever for opening and closing the damper.

16. The method of claim 15, including providing a power actuator mechanism comprising a power actuator (hiving a position member that is operatively connected to a portion of the lever.

17. The method of claim 16, including providing a position member including a body having an arcuate slot interfacing with the portion of the lever.

18. The method of claim 16, including providing a position sensor operatively associated with the power actuator.

19. The method of claim 18, further including the steps of:
by the power actuator under control of the controller and optionally the position sensor, holding the position member in a neutral orientation whereby the lever is not moved by the position member during a manual actuation of the vent register damper by the manual actuator mechanism; and
by the power actuator under control of the controller and optionally the position sensor, on determining a one of the one or more predefined conditions translating the position member sufficiently from the neutral orientation to cause the lever to translate the vent register damper to the desired orientation at or between a fully open position and a fully closed position.

20. The method of claim 15, wherein the one or more predefined conditions are selected from the group consisting of detecting an unoccupied vehicle seat, detecting a vehicle heating, air conditioning, and ventilation (HVAC) system defrost mode, determining a need for operation of a specific zone of a multiple-zone HVAC system, determining a need for altering a temperature of a specific zone of the multiple-zone HVAC system, and determining a need for adjusting a combined airflow allowed through two or more vent registers.
